(19) United States
(12) Patent Application Publication
(10) Pub. No.: US 2022/0194432 A1
(43) Pub. Date: Jun. 23, 2022

(54) AUTOMATIC DRIVING VEHICLE

(71) Applicant: TOYOTA JIDOSHA KABUSHIKI KAISHA, Toyota-shi Aichi-ken (JP)

(72) Inventor: Hirohito Ide, Nagoya-shi Aichi-ken (JP)

(73) Assignee: TOYOTA JIDOSHA KABUSHIKI KAISHA, Toyota-shi Aichi-ken (JP)

(21) Appl. No.: 17/523,319

(22) Filed: Nov. 10, 2021

(30) Foreign Application Priority Data
Dec. 18, 2020 (JP) 2020-210010

(51) Int. Cl. B60W 60/00

(52) U.S. Cl. CPC B60W 60/0053; B60W 2552/00; B60W 2520/12; B60W 2520/10

(57) ABSTRACT

A driving control device controls traveling of an automatic driving vehicle. The driving control device includes a control unit, and as driving modes, the control unit has at least two driving modes including an automatic driving mode of performing an automatic control of the traveling of the vehicle and a manual driving mode of controlling the traveling of the vehicle in response to an operation by an operator that rides on the vehicle. The control unit sets an upper limit vehicle speed in the manual driving mode to a vehicle speed lower than an upper limit vehicle speed in the automatic driving mode, when the driving mode switches from the automatic driving mode to the manual driving mode.

### CROSS-REFERENCE TO RELATED APPLICATION

This application claims priority to Japanese Patent Application No. 2020-210010 filed on Dec. 18, 2020, incorporated herein by reference in its entirety.

### BACKGROUND

### 1. Technical Field

The present disclosure relates to an automatic driving vehicle having an automatic driving mode and a manual driving mode as driving modes.

### 2. Description of Related Art

Conventionally, an automatic driving vehicle has been known that can perform an automatic driving. The automatic driving means a driving in which a computer executes at least a part of a driving control including a turning angle control (steering control) and vehicle speed control of a vehicle, and typically means a driving in which a traveling control of the vehicle is performed with no operation by an operator such as a driver.

Even the automatic driving vehicle that can perform the automatic driving often has a manual driving mode, because the operator should manually perform the driving control of the vehicle depending on situation.

Japanese Unexamined Patent Application Publication No. 2019-206257 (JP 2019-206257 A) discloses that the driving mode switches from the automatic driving control to the manual driving control in the case of the arrival at a scheduled end place for the automatic driving or in the case of vehicle malfunction. Further, in JP 2019-206257 A, when the switching from the automatic driving control to the manual driving control is performed without driver's intention, the drive force of one drive wheel is distributed to the other drive wheel, in the case where the drive force of the one drive wheel is equal to or higher than a predetermined force (is exceeding a maximum frictional force) in consideration of the maximum frictional coefficient of a road surface on which the vehicle travels.

### SUMMARY

JP 2019-206257 A is aimed at preventing the vehicle from skidding due to a strong depression of an accelerator by the driver, in the case where the switching from the automatic driving control to the manual driving control is performed without driver's intention. The skid easily occurs at the time of steering, and in the automatic driving mode, the vehicle is controlled such that the skid does not occur due to steering. On the other hand, in the manual driving mode, there is often no restriction about steering, and the skid easily occurs.

An automatic driving vehicle according to the present disclosure has at least two driving modes including an automatic driving mode of performing an automatic control of traveling of a vehicle and a manual driving mode of controlling the traveling of the vehicle in response to an operation by an operator that rides on the vehicle, the automatic driving vehicle setting an upper limit vehicle speed in the manual driving mode to a vehicle speed lower than an upper limit vehicle speed in the automatic driving mode, when the driving mode switches from the automatic driving mode to the manual driving mode.

The manual driving mode may include a plurality of types of manual driving modes, and a type of manual driving mode in which the upper limit vehicle speed in the manual driving mode is lower than the upper limit vehicle speed in the automatic driving mode may be selected from the plurality of types of manual driving modes, when the driving mode switches from the automatic driving mode to the manual driving mode.

During traveling in the manual driving mode, selection of the type of the manual driving mode may be controlled depending on environmental information about a road on which the vehicle travels.

With the present disclosure, it is possible to restrain the occurrence of the skid or the like in the manual driving mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external view of an automatic driving vehicle 10 according to an embodiment;

FIG. 2 is a functional block diagram of a driving control device 20 according to the embodiment;

FIG. 3 is a diagram showing an exemplary screen that is displayed on a touch panel 22, and shows a state at the time of vehicle stop in an automatic driving mode;

FIG. 4 is a diagram showing an exemplary screen that is displayed on the touch panel 22, and shows a state at the time of traveling in the automatic driving mode;

FIG. 5 is a perspective view of a mechanical operation unit 24 in the embodiment; and

FIG. 6 is a diagram showing an exemplary display of type selection buttons in a manual driving mode.

### DETAILED DESCRIPTION OF EMBODIMENTS

An embodiment of the present disclosure will be described below based on the drawings. The present disclosure is not limited to the embodiment described herein.

Overall Configuration

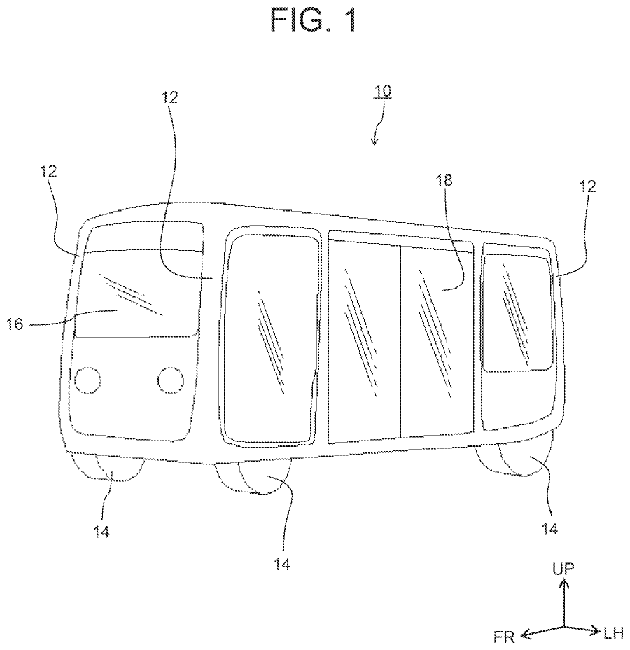

FIG. 1 is an external view of an automatic driving vehicle 10 according to an embodiment. In the figure, “forward (FR)” and “rearward” mean “forward” and “rearward” in a vehicle front-rear direction, “leftward (LH)” and “rightward” mean “leftward” and “rightward” when the automatic driving vehicle 10 faces forward, and “upward (UP)” and “downward” mean “upward” and “downward” in a vehicle up-down direction.

The automatic driving vehicle 10 has a roughly rectangular parallelepiped shape and has a nearly front-rear symmetric shape, and the external design also has a front-rear symmetric shape. Pillars 12 extending in an up-down direction are provided at four corners of the automatic driving vehicle 10 in planar view. Wheels 14 are provided below the pillars 12. A transparent or translucent panel 16 is partially provided on each of front, rear, right and left sidewalls of the automatic driving vehicle 10. The panel 16 may be a display panel, and characters and others may be displayed on the display panel.

A panel that is a part of the left-side surface is a slidable door 18, and the door 18 is slid and opened, so that an occupant can get on or get off the automatic driving vehicle 10. Although not illustrated in FIG. 1, a slope that can be taken in and out is stored below the door 18. The slope is used, for example, when a person in a wheelchair gets on or gets off the automatic driving vehicle 10.

The automatic driving vehicle 10 is a share-ride vehicle on which many and unspecified occupants ride. The many and unspecified occupants include an operator that performs a control (including a driving control) of the automatic driving vehicle 10. In the embodiment, the automatic driving vehicle 10 is used as a bus that transports passengers while traveling along a prescribed route in a particular site. Accordingly, it is assumed that the automatic driving vehicle 10 repeats stop and start with relatively high frequency. Further, it is assumed that the automatic driving vehicle 10 travels at relatively low speed (for example, at 30 km/h or lower).

The use form of the automatic driving vehicle 10 disclosed in the present specification can be changed when appropriate. For example, the automatic driving vehicle 10 may be used as a business space that can move, or may be used as a store such as a retail shop in which various products are displayed and sold and a restaurant in which food and drink are cooked and provided. As another form, the automatic driving vehicle 10 may be used as an office in which a clerical work, an arrangement with a client, or the like is performed. The use scene of the automatic driving vehicle 10 is not limited to business, and for example, the automatic driving vehicle 10 may be used as personal movement device. Further, the traveling pattern of the automatic driving vehicle 10 may be changed when appropriate.

The automatic driving vehicle 10 in the embodiment is an electric vehicle including a drive motor that receives electric power supply from a battery, as a prime mover. The battery is a secondary battery that can be charged and discharged, and is periodically charged by external electric power. The automatic driving vehicle 10 is not limited to the electric vehicle, and another type of vehicle may be adopted. For example, the automatic driving vehicle 10 may be an engine vehicle that is equipped with an engine as a prime mover, or may be a hybrid vehicle that is equipped with an engine and a drive motor as prime movers. Furthermore, the automatic driving vehicle 10 may be a hydrogen vehicle that drives a drive motor using electric power generated by a fuel cell.

The automatic driving vehicle 10 is a vehicle that can perform an automatic driving. Specifically, the automatic driving vehicle 10 can travel in a plurality of driving modes including an automatic driving mode, a semi-automatic driving mode and a manual driving mode.

Functional Block

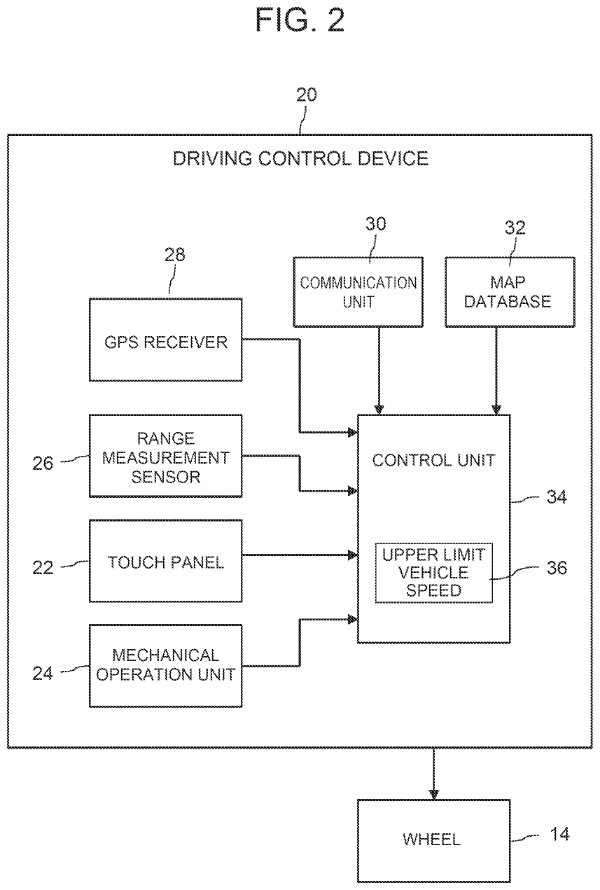

FIG. 2 is a functional block diagram of a driving control device 20 according to the embodiment. In the embodiment, each unit included in the driving control device 20 is equipped in the automatic driving vehicle 10.

A touch panel 22 is configured to include a flat display such as a liquid crystal display and an organic electroluminescence display, for example, and a touch sensor that detects a touch to the display. The touch panel 22 may be provided near an operator's seat in the vehicle, such that the operator riding on the automatic driving vehicle 10 can suitably operate the touch panel 22.

The operator manually operates a mechanical operation unit 24, so that the driving control of the automatic driving vehicle 10 is performed. The mechanical operation unit 24 mechanically acts by being operated by the operator. The mechanical operation unit 24 is operated by hand, unlike an accelerator pedal and a brake pedal that are provided in a conventional automobile. Accordingly, the mechanical operation unit 24 is provided, at least, on the upper side of a seating surface of the operator's seat. In some embodiments, the mechanical operation unit 24 may be provided on an arm rest on which the operator's arm is placed, in order that the operator can easily operate the mechanical operation unit 24 by hand.

When the mechanical operation unit 24 is operated by the operator, operation information indicating an operation content (for example, an operation direction) and an operation amount is sent from the mechanical operation unit 24 to a control unit 34 described later. Based on the operation information, various driving controls of the automatic driving vehicle 10 are executed by the control unit 34. In the embodiment, a vehicle speed control and a turning angle control of the automatic driving vehicle 10 can be executed through the mechanical operation unit 24.

The mechanical operation unit 24 is mainly used in the case where the driving mode of the automatic driving vehicle 10 is the manual driving mode. However, it is allowable to adopt a configuration in which the driving control can be performed through the mechanical operation unit 24 even in the case where the driving mode of the automatic driving vehicle 10 is the automatic driving mode or the semi-automatic driving mode. In the case of the automatic driving mode or the semi-automatic driving mode, a driving control instruction from the mechanical operation unit 24 has priority over a driving control instruction from a management center or a driving control based on detection results of various sensors (for example, a camera or a LIDAR, and others) included in the automatic driving vehicle 10.

Back to FIG. 2, for example, a range measurement sensor 26 is configured to include a camera that photographs the periphery (front, rear, right and left sides) of the vehicle, or a LIDAR that measures the distance to an obstacle that is positioned in the periphery of the vehicle. The range measurement sensor 26 is a sensor that detects the size of a traveling-possible region in the periphery of the automatic driving vehicle 10. The traveling-possible region is a region where the automatic driving vehicle 10 can travel. For example, it is possible to detect the road width of a road on which the automatic driving vehicle 10 is traveling, from an image photographed by a camera as the range measurement sensor 26. Further, it is possible to measure the distance to an obstacle (a sidewall or the like) on the front, rear, right or left side of the automatic driving vehicle 10, by a camera or a LIDAR as the range measurement sensor 26.

A GPS receiver 28 is a device that receives signals from satellites and that detects the current position, and another global navigation satellite system (GNSS) or the like may be used.

A communication unit 30 can communicate with the management center or the like through the internet, for example, and can obtain information (driving control instruction) necessary for traveling, or the like. A map database 32, in which map information about an area where the automatic driving vehicle 10 can travel is stored, is used, for example, when a navigation device functions. Further, in the map database 32, environmental information about the road on which the automatic driving vehicle 10 travels is also stored as the map information. The environmental information includes road information such as the curvature and road width of the road and facility information such as information of whether a school is in the periphery.

The control unit 34 is configured to include a central processing unit (CPU), a read only memory (ROM), a random access memory (RAM) or an embedded multimedia card (eMMC). The control unit 34 performs various arithmetic processes that are necessary in the driving control device 20, and performs an acceleration-deceleration control, a steering control and the like. In the control unit 34, an upper limit vehicle speed storage unit 36 is provided, and the control unit 34 restricts the vehicle speed during traveling, by an upper limit vehicle speed stored in the upper limit vehicle speed storage unit 36. The upper limit vehicle speed includes an upper limit vehicle speed in the automatic driving mode and an upper limit vehicle speed in the manual driving mode, and the upper limit vehicle speed in the manual driving mode includes a plurality of upper limit vehicle speeds corresponding to traveling types.

Configuration of Touch Panel

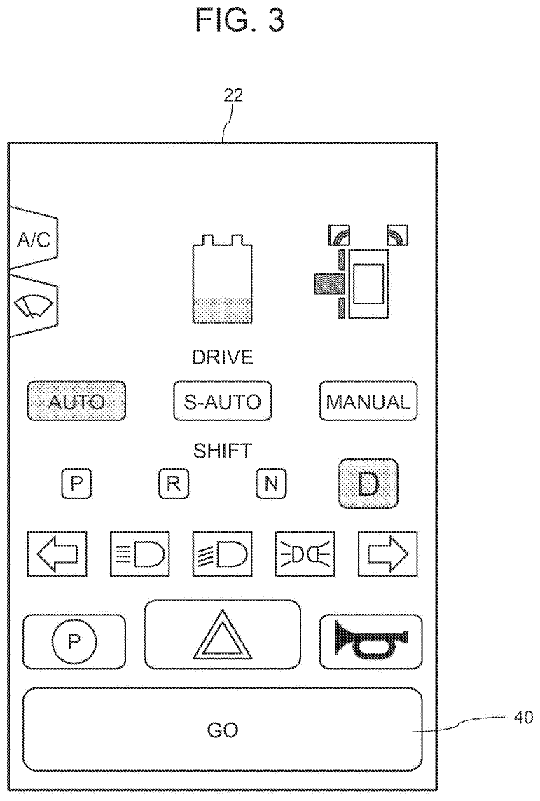

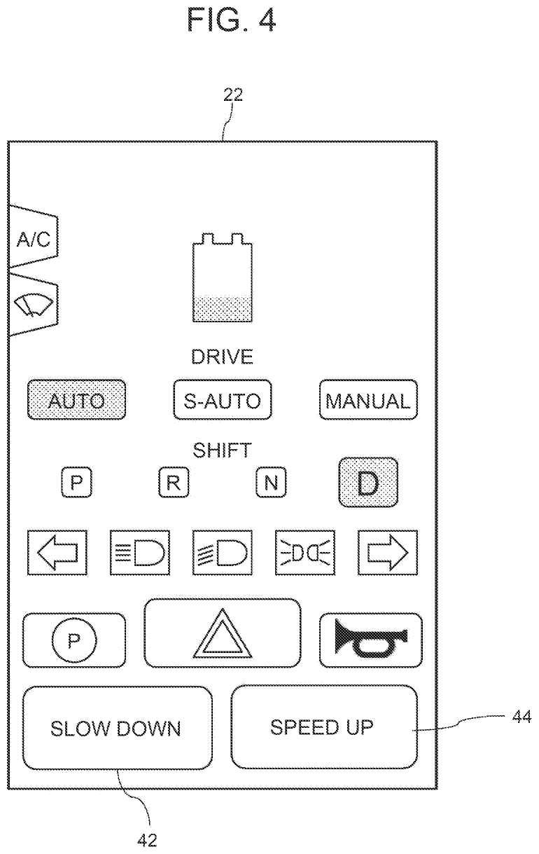

FIG. 3 and FIG. 4 are diagrams showing exemplary screens that are displayed on the touch panel 22. FIG. 3 shows a state at the time of vehicle stop in the automatic driving mode, and FIG. 4 shows a state at the time of traveling in the automatic driving mode. The figures show states in the automatic driving mode, and “AUTO” is selected and displayed (sand-like display), as the driving mode (DRIVE). In the case of the manual driving mode, “MANUAL” is selected and displayed.

Various buttons are displayed on the touch panel 22, and the operator can input driving control instructions to the automatic driving vehicle 10, through the buttons displayed on the touch panel 22. Particularly, the operator can cause the automatic driving vehicle 10 to start, by operating a GO button 40 displayed on the touch panel 22 shown in FIG. 3. In the case where the driving mode of the automatic driving vehicle 10 is the automatic driving mode or the semi-automatic driving mode, the automatic driving is started after the start of the automatic driving vehicle 10 due to the operation of the GO button 40. In this case, after the start of the automatic driving vehicle 10, as shown in FIG. 4, a SLOWDOWN button 42 for decelerating the automatic driving vehicle 10 and a SPEEDUP button 44 are displayed on the touch panel 22, instead of the GO button 40. By operating the SLOWDOWN button 42, the operator can perform the deceleration control of the automatic driving vehicle 10 even during the automatic driving. Further, in the case where the vehicle speed is equal to or lower than the upper limit vehicle speed in the automatic driving, the acceleration control can be performed through the SPEEDUP button 44. In the case where the driving mode of the automatic driving vehicle 10 is the manual driving mode, the operator drives the automatic driving vehicle 10, by operating the mechanical operation unit 24 described later, after the operation of the GO button 40. In the case where the acceleration and deceleration can be performed by the mechanical operation unit 24 described later, the operation of the SLOWDOWN button 42 and the SPEEDUP button 44 may be prohibited.

Configuration of Mechanical Operation Unit

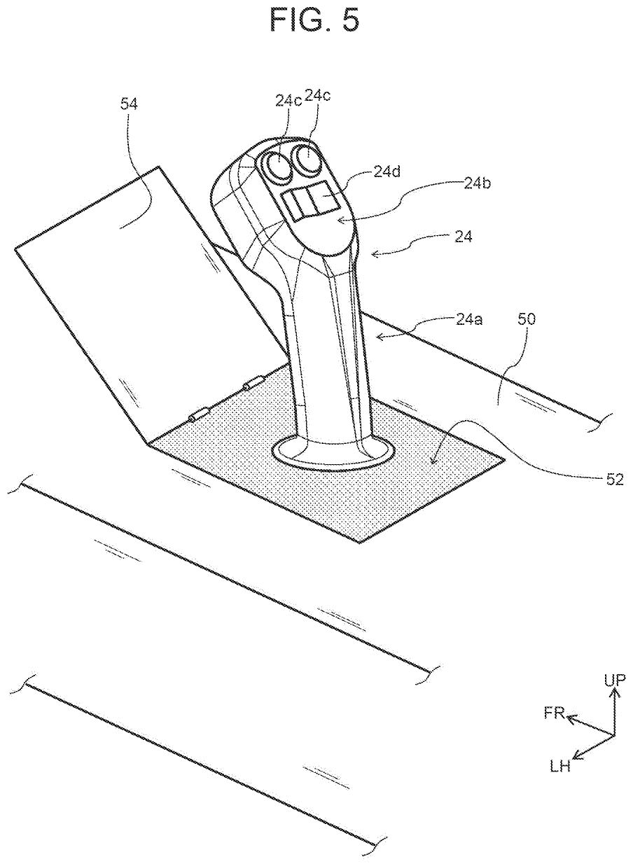

FIG. 5 is a perspective view of the mechanical operation unit 24 in the embodiment. In the embodiment, the mechanical operation unit 24 has a stick shape that extends in the up-down direction. Specifically, the mechanical operation unit 24 is configured to include a grip portion 24a having a shape that extends in the up-down direction, and a switch base portion 24b positioned on the upper side of the grip portion 24a. The operator can perform a lever operation of the mechanical operation unit 24 while gripping the grip portion 24a. Specifically, the mechanical operation unit 24 can be pressed down in the forward, rearward, rightward and leftward directions, while a lower end is used as a pivot point. In the case where the operator loses operator's grip of the mechanical operation unit 24, that is, in the case where the operator does not operate the mechanical operation unit 24, the mechanical operation unit 24, by itself, returns to a state (referred to as a “neutral state” in the present specification) where the extension direction of the grip portion 24a coincides with the vertical direction.

When the mechanical operation unit 24 is pressed down in one of the forward, rearward, rightward and leftward directions, the operation information indicating the direction of the press as the operation content and the angle of the press as the operation amount is sent to the control unit 34. In the embodiment, the automatic driving vehicle 10 is accelerated when the mechanical operation unit 24 is pressed down forward, the automatic driving vehicle 10 is decelerated when the mechanical operation unit 24 is pressed down rearward, the automatic driving vehicle 10 is turned in the rightward direction (that is, the turning angle of the automatic driving vehicle 10 becomes large in the rightward direction) when the mechanical operation unit 24 is pressed rightward, and the automatic driving vehicle 10 is turned in the leftward direction (that is, the turning angle of the automatic driving vehicle 10 becomes large in the leftward direction) when the mechanical operation unit 24 is pressed down leftward.

The switch base portion 24b is provided with a directional indicator switch 24c for causing a directional indicator to act and a horn switch 24d for causing a horn to act. Thereby, through the mechanical operation unit 24, it is possible to perform the control of apparatuses (the directional indicator and the horn) provided in the automatic driving vehicle 10, in addition to the driving control.

In the embodiment, as shown in FIG. 5, the mechanical operation unit 24 stands on an arm rest 50 on which the operator's arm is placed, in an enabled state. The mechanical operation unit 24 can be stored in a storage portion 52 provided in the arm rest 50, by being pushed downward in the enabled state. In some embodiments, the storage portion 52 may be provided with a lid 54. When the mechanical operation unit 24 is not used, the mechanical operation unit 24 is stored in the storage portion 52, so that the mechanical operation unit 24 is prevented from being mistakenly operated.

The automatic driving vehicle 10 does not include an operation unit that mechanically acts for the driving control of the automatic driving vehicle 10, other than the mechanical operation unit 24. For example, the automatic driving vehicle 10 is not provided with a foot-operated pedal for inputting a vehicle speed control instruction, as exemplified as an accelerator pedal and a brake pedal, which are provided in conventional automobiles and the like.

As for the relation between the operation amount (the amount of the rightward or leftward pressing) of the mechanical operation unit 24 and the turning angle, the change amount may be large in a region in which the operation amount is large, instead of a linear relation. Further, the above relation may be changed depending on traveling environment.

Driving Mode

The driving mode of the automatic driving vehicle 10 includes three kinds of driving modes: the automatic driving mode, the semi-automatic driving mode and the manual driving mode.

The automatic driving mode is a driving mode in which the computer (the control unit 34) equipped in the automatic driving vehicle 10 performs a large part of the driving control. In the present specification, the driving control is a concept including a gear shift control, the vehicle speed control or the steering control (that is, the turning angle control of the automatic driving vehicle 10). The vehicle speed control is a concept including a start control, stop control and acceleration-deceleration control of the automatic driving vehicle 10. The automatic driving vehicle 10 can communicate with the management center that manages and controls a plurality of automatic driving vehicles 10, and in the automatic driving mode, the automatic driving vehicle 10 travels along a previously decided route, by the control from the management center. In the automatic driving mode, the driving control is performed by the computer, in accordance with a driving control instruction from the management center. However, a start control in the stop state may be performed in response to the operator's operation. Further, during the automatic driving in the automatic driving mode, the operator can accelerate or decelerate the automatic driving vehicle 10. The control by the operator may be limited to the deceleration, and the acceleration may depend on the control by the driving control device 20.

In the automatic driving mode, the vehicle speed is controlled by the control unit 34. The upper limit vehicle speed of the automatic driving vehicle 10 in the automatic driving mode can be set in the upper limit vehicle speed storage unit 36, and for example, the upper limit vehicle speed may be set to 19 km/h. Without being limited to 19 km/h, the upper limit vehicle speed can be set to a desired value depending on the traveling environment, specifications of the automatic driving vehicle 10 and the like, and for example, is set to 30 km/h. Thereby, in the case where the vehicle speed exceeds the upper limit vehicle speed stored as a vehicle speed obtained by an optimization calculation in which a forward vehicle, a road surface condition, a speed limit and the like are considered, the vehicle speed is restricted to the upper limit vehicle speed. Further, the upper limit vehicle speed may be changed so as to decrease. Thereby, it is possible to set the upper limit vehicle speed for each vehicle, without changing the optimization calculation itself.

Similarly to the automatic driving mode, the semi-automatic driving mode is a driving mode in which the driving control device 20 performs a large part of the driving control of the automatic driving vehicle 10. In the semi-automatic driving mode, without depending on the driving control instruction from the management center, the driving control device 20 performs the driving control based on detection results of various sensors (for example, a camera or a LIDAR, and others) included in the automatic driving vehicle 10. In the semi-automatic driving mode also, the start control in the stop state may be performed by the operator's operation. Further, even during the automatic driving in the semi-automatic driving mode, the operator can decelerate the automatic driving vehicle 10. The setting of the upper limit vehicle speed may be the same as that in the automatic driving mode.

The manual driving mode is a mode in which the automatic driving vehicle 10 does not perform the automatic driving and the operator performs the driving control of the automatic driving vehicle 10. For example, the manual driving mode includes three types of manual driving modes described below.

(i) Default type: The upper limit vehicle speed is 7 km/h, and a stationary steering (a steering operation in the stop state) is prohibited.

(ii) Narrow road type: The upper limit vehicle speed is 7 km/h, and the stationary steering is permitted. The turning angle by which the operation can be performed is larger than that in the default type.

(iii) High speed type: The upper limit vehicle speed is 19 km/h, and the stationary steering is prohibited. The upper limit vehicle speed can be changed to the upper limit vehicle speed in the automatic driving mode.

As described above, when the automatic driving vehicle 10 travels along a prescribed route in a particular site, the automatic driving vehicle 10 basically travels in the automatic driving mode. The manual driving mode is used, for example, at the time when the automatic driving vehicle 10 moves from a waiting place to the prescribed route, at the time when the automatic driving vehicle 10 moves from the prescribed route to the waiting place, or at the time of occurrence of an abnormality such as communication failure or emergency stop. The semi-automatic driving mode is used, for example, in the case where the instruction from the management center is not sent due to communication failure or the like.

Switching of Driving Mode

As shown in FIG. 3 and FIG. 4, “AUTO” for the automatic driving mode, “S-AUTO” for the semi-automatic driving mode and “MANUAL” for the manual driving mode are displayed on the touch panel 22. Accordingly, by operating them, it is possible to switch the driving mode. However, the timing of the mode switching may be limited, and the driving mode may be switched by the operation of the above display buttons, only at the timing when the switching can be performed.

Traveling Control

For example, when the system is activated in a state where the automatic driving vehicle 10 waits in a garage (when an electric power source and an ignition are turned on and the automatic driving vehicle 10 becomes a state allowing traveling), the system is first activated as the manual driving mode (the default type). On this occasion, automatically, the lid 54 may be opened, and the mechanical operation unit 24 may become an operation state where the mechanical operation unit 24 stands. Then, by the operator's operation, the automatic driving vehicle 10 moves to the waiting place for entering the prescribed route.

Then, in the entrance waiting place, the automatic driving vehicle 10 becomes a waiting state for the automatic driving mode, and in response to an entrance instruction from the management center, the automatic driving vehicle 10 enters the prescribed route and starts the traveling in the automatic driving mode.

Thereafter, the automatic driving vehicle 10 travels along the prescribed route at a designated vehicle speed, in accordance with an instruction that is sent from the management center. In the case where the automatic driving vehicle 10 is a fixed route bus or the like, a stop program or a start program is executed in a station, so that the stop or the start is performed. In the embodiment, in the case where the automatic driving vehicle 10 stops in the station or the like, the automatic driving vehicle 10 starts in response to the operator's operation of the GO button 40 on the touch panel 22.

When the traveling in the automatic driving mode according to a schedule finishes, the automatic driving vehicle enters an exit waiting place in the garage and stops, based on an automatic driving control by the execution of an exit program. Thereby, the automatic driving mode finishes, and the driving mode transitions to the manual driving mode (the default type). On this occasion, automatically, the lid 54 may be opened, and the mechanical operation unit 24 may become the operation state where the mechanical operation unit 24 stands. Then, by the operator's operation, the automatic driving vehicle 10 is parked at a desired parking position in the garage, and a preparation such as a charge is performed for the next traveling.

In the case where an obstacle is found during the traveling in the automatic driving mode, in the case where an emergency stop button is pressed, or in other cases, an emergency stop program is executed, so that the automatic driving vehicle 10 immediately stops, or stops at a safe place such as a roadside. In this case, the driving mode switches to the manual driving mode (the default type).

In the case of the semi-automatic driving mode, when the operator operates the GO button 40 on the touch panel 22 and the control unit 34 receives a start instruction from the touch panel 22, the control unit 34 causes the automatic driving vehicle 10 to start. Thereafter, the control unit 34 performs the vehicle speed control and the turning angle control based on detection results of various sensors included in the automatic driving vehicle 10.

Switching from Automatic Driving Mode to Manual Driving Mode

In some cases, even during the traveling in the automatic driving mode, it is desirable to switch to the manual driving mode for any reason. Examples of the cases include a case where the automatic driving vehicle 10 needs to perform a traveling other than a prescribed traveling based on information from the management center although the automatic driving vehicle 10 is safely traveling. In that case, the mechanical operation unit 24 is placed into an operable state, by the operator's operation. Thereby, the “MANUAL” button for the manual driving mode on the touch panel 22 becomes an operable state, so that the driving mode can be changed. When the “MANUAL” button for the manual driving mode is operated, the driving mode transitions to the manual driving mode (the default type).

In this way, in the case of the transition from the automatic driving mode to the manual driving mode, the driving mode basically transitions to the default type. The upper limit driving speed in the default type is set to a vehicle speed lower than the upper limit vehicle speed in the automatic driving mode. Further, it is allowable to adopt a configuration in which the switching to the high speed type can be performed only after the driving mode transitions to the default type once, in the case where the driving mode is switched to the manual driving mode during the traveling in the automatic driving mode. Thereby, it is possible to prevent the drive force of the drive wheel from becoming excessively high, in the case where the high speed type is selected due to an erroneous operation by the operator.

In the automatic driving mode, both the vehicle speed control and the steering control are performed by the driving control device 20. Accordingly, it is possible to prevent the drive force of the drive wheel from exceeding a maximum frictional force due to steering, so that it is possible to prevent a traveling that causes a skid. On the other hand, in the manual driving mode, the steering also is manually performed, and therefore, the drive force of the drive wheel can exceed the maximum frictional force, leading to the traveling that causes the skid. In the embodiment, the upper limit vehicle speed in the manual driving mode is set to a vehicle speed lower than the upper limit vehicle speed in the automatic driving mode. Thereby, it is possible to restrain the occurrence of the skid due to the steering.

Switching to Other Driving Modes

In the case where the manual driving mode finishes, the automatic driving vehicle 10 may return to the garage once and thereafter the driving mode may transition to the automatic driving mode at an ordinary entrance waiting place. For example, after the emergency stop, it is sometimes desirable to return to the automatic driving at that place. In this case, the automatic driving vehicle 10 may be placed into a waiting state once, and the driving mode may return to the automatic driving mode in response to an instruction from the management center.

In the case where communication failure or the like occurs during the traveling in the automatic driving mode, the driving mode transitions to the semi-automatic driving mode. In the case of the traveling in the semi-automatic driving mode, the automatic driving vehicle 10 may return to the garage once, by traveling along the prescribed route. Further, in the case where the communication is recovered during the traveling in the semi-automatic driving mode, the driving mode may become the automatic driving mode again, based on an instruction from the management center.

Traveling in Manual Driving Mode

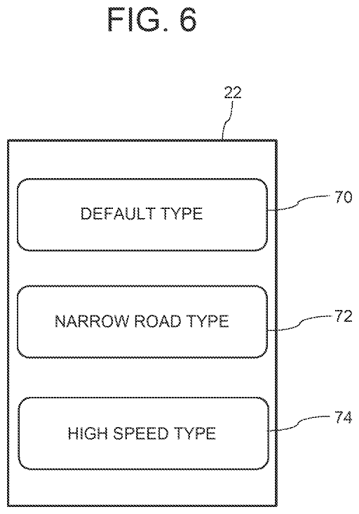

As described above, the manual driving mode includes a plurality of (three) types: (i) the default type, (ii) the narrow road type, and (iii) the high speed type. For example, in the case where the manual driving mode is selected, the types may be displayed at appropriate places on the touch panel 22 (for example, the types are displayed at places with no display, or are displayed instead of the SLOWDOWN button or the SPEEDUP button). FIG. 6 is a diagram showing an exemplary display of type selection buttons in the manual driving mode that are displayed on the touch panel 22 including a DEFAULT TYPE button 70, a NARROW ROAD TYPE button 72, and a HIGH SPEED TYPE button 74. As the display form, a vertically long form, a horizontally long form or the like may be employed depending on the display place.

The operator selects one of the above buttons, and thereby, can select the type of the manual driving mode, so that the driving control is performed in the selected type.

The selection of the type of the manual driving mode can be controlled as follows.

(i) The type of the manual driving mode is automatically selected, based on traveling environment such as a road on which the automatic driving vehicle 10 travels, road widths of a set route to a destination, and surrounding facilities (for example, a school).

(ii) The selection of the type is restricted based on the above traveling environment. For example, the selection of the high speed type is prohibited on a curve.

Control with Mechanical Operation Unit

Regardless of the driving mode of the automatic driving vehicle 10, the control unit 34 performs the driving control of the automatic driving vehicle 10, in response to the operation of the mechanical operation unit 24.

Specifically, the control unit 34 controls the turning angle (of the wheel 14) of the automatic driving vehicle 10, based on the operation amount of the mechanical operation unit 24 in the rightward or leftward direction. Further, the control unit 34 controls the drive motor, the engine or a brake device, based on the operation amount of the mechanical operation unit 24 in the forward or rearward direction, and thereby, performs the vehicle speed control of the automatic driving vehicle 10. In this way, the control unit 34 functions as a vehicle speed control unit. More specifically, the control unit 34 accelerates the automatic driving vehicle 10 as the mechanical operation unit 24 is pressed down in the forward direction, and decelerates the automatic driving vehicle 10 as the mechanical operation unit 24 is pressed down in the rearward direction.

In the embodiment, in the case where the driving mode of the automatic driving vehicle 10 is the manual driving mode, where the automatic driving vehicle 10 is traveling and where the mechanical operation unit 24 is not being operated by the operator (the mechanical operation unit 24 is in the neutral state), the control unit 34 controls the automatic driving vehicle 10 such that the automatic driving vehicle 10 decelerates. Thereby, it is possible to prevent the automatic driving vehicle 10 from continuing to travel, in the case where the driving mode of the automatic driving vehicle 10 is the manual driving mode, where the automatic driving vehicle 10 is traveling and where the operator cannot operate the mechanical operation unit 24 for any reason. That is, it is possible to secure the safety of the automatic driving vehicle 10.

Further, in the case where the driving mode of the automatic driving vehicle 10 is the manual driving mode, where the automatic driving vehicle is in the stop state and where the mechanical operation unit 24 is not being operated by the operator, the control unit 34 controls the automatic driving vehicle 10 such that the automatic driving vehicle 10 is maintained in the stop state. More specifically, the control unit 34 maintains the automatic driving vehicle 10 in the stop state, such that the automatic driving vehicle 10 is avoided from moving forward due to a creep phenomenon, or such that the automatic driving vehicle 10 is avoided from sliding down due to inclination in the case where the automatic driving vehicle 10 is stopped on a sloping road.

As a control for maintaining the automatic driving vehicle 10 in the stop state, the brake device may be controlled such that the automatic driving vehicle 10 is braked, or the drive motor or the engine may be controlled such that a torque allowing the stop state to be maintained is generated.

Other Configurations of Mechanical Operation Unit

In the above-described embodiment, the mechanical operation unit 24 has a stick shape, and can be pressed down in the forward, rearward, rightward and leftward directions. However, the mechanical operation unit 24 is not limited to this. For example, the mechanical operation unit 24 may be a sliding knob that can move in the forward, rearward, rightward and leftward directions. In this case, the operation amount of the mechanical operation unit 24 is a movement amount of the sliding knob in the rightward or leftward direction, and the control unit 34 as a turning angle control unit controls the turning angle of the automatic driving vehicle 10, depending on selective turning angle characteristic and the movement amount of the sliding knob in the rightward or leftward direction.

The mechanical operation unit 24 may be an arrow key (a composite button constituted by four buttons corresponding to the forward, rearward, rightward and leftward directions) included in a game controller. In this case, the operation amount of the mechanical operation unit 24 is a time during which a right or left button of the arrow key continues to be pressed, and the control unit 34 as the turning angle control unit controls the turning angle of the automatic driving vehicle 10, depending on the selective turning angle characteristic and the time during which the right or left button of the arrow key continues to be pressed.

In the above-described embodiment, each unit of the driving control device 20 is equipped in the automatic driving vehicle 10, and the mechanical operation unit 24 is operated by the operator that rides on the automatic driving vehicle 10. However, the mechanical operation unit 24 may be provided in the exterior of the automatic driving vehicle 10. For example, the mechanical operation unit 24 may be provided in the management center that manages a plurality of automatic driving vehicles 10.

What is claimed is:

1. An automatic driving vehicle having at least two driving modes including an automatic driving mode of performing an automatic control of traveling of a vehicle and a manual driving mode of controlling the traveling of the vehicle in response to an operation by an operator that rides on the vehicle,
the automatic driving vehicle setting an upper limit vehicle speed in the manual driving mode to a vehicle speed lower than an upper limit vehicle speed in the automatic driving mode, when the driving mode switches from the automatic driving mode to the manual driving mode.

2. The automatic driving vehicle according to claim 1, wherein the manual driving mode includes a plurality of types of manual driving modes, and a type of manual driving mode in which the upper limit vehicle speed in the manual driving mode is lower than the upper limit vehicle speed in the automatic driving mode is selected from the plurality of types of manual driving modes, when the driving mode switches from the automatic driving mode to the manual driving mode.

3. The automatic driving vehicle according to claim 2, wherein during traveling in the manual driving mode, selection of the type of the manual driving mode is controlled depending on environmental information about a road on which the vehicle travels.
